(19) United States
(12) Patent Application Publication
(10) Pub. No.: US 2012/0098946 A1
(43) Pub. Date: Apr. 26, 2012

(54) IMAGE PROCESSING APPARATUS AND METHODS OF ASSOCIATING AUDIO DATA WITH IMAGE DATA THEREIN

(75) Inventor: Jung-ah Seung, Guri-si (KR)

(73) Assignee: Samsung Electronics Co., Ltd., Suwon-si (KR)

(21) Appl. No.: 13/270,402

(22) Filed: Oct. 11, 2011

(30) Foreign Application Priority Data
Oct. 26, 2010 (KR) 10-2010-0104842

(51) Int. Cl. H04N 7/18

(52) U.S. Cl. 348/61

(57) ABSTRACT

A method and apparatus to associate audio data and image data are disclosed herein. Disclosed embodiments include detecting a specific region in image data obtained by an image capturing apparatus, acquiring audio data that will be associated with the detected specific region from a user, and generating audio data connection information needed for associating the acquired audio data with the detected specific region. When user selects a specific region to which audio data is associated, the image capturing apparatus reproduces the audio data connected to the specific region.

### CROSS-REFERENCE TO RELATED PATENT APPLICATION

This application claims the priority benefit of Korean Patent Application No. 10-2010-0104842, filed on Oct. 26, 2010, in the Korean Intellectual Property Office, the entire disclosure of which is incorporated herein by reference.

### BACKGROUND

1. Field of the Invention

The invention relates to image processing apparatus and methods of associating audio data with image data in the image processing apparatus.

2. Description of the Related Art

Image capturing devices such as digital cameras allow users to capture images, record detailed data associated with the captured images, and store the recorded data together with the captured image data. However, conventional image capturing devices are configured to store only one piece of recorded data for each captured image data. This prevents a user from recording details for each of the objects in the image data.

Thus, in order to create various sound and audio effects for one piece of image data, there is a need to record and reproduce audio for each object in image data.

### SUMMARY

An embodiment of the invention provides an image capturing apparatus and methods of associated audio data with image data in the image capturing apparatus, which are capable of recognizing a specific region of image data and generating audio data connection information needed for associating the audio data with the recognized specific region.

According to an embodiment, there is provided a method of associating image data with audio data in an image capturing apparatus, including: displaying image data having indicated thereon a specific region that is recognized in a photography standby mode of the image capturing apparatus; acquiring audio data corresponding to the recognized specific region; generating audio data connection information to associate the acquired audio data with the recognized specific region; and storing the generated audio data connection information.

The specific region recognized in a photography standby mode of the image capturing apparatus may be a region defined for auto focus by the image capturing apparatus in the photography standby mode. The specific region may be a region identified by the image capturing apparatus as a face region in the photography standby mode.

Displaying the image data containing the recognized specific region may include indicating an icon on the recognized specific region.

The method may further include receiving an input of a region other than the recognized specific region, acquiring second audio data corresponding to the other region, and generating second audio data connection information needed for associating the acquired second audio data with the other region.

When the recognized specific region includes a plurality of regions, the audio data is acquired for each of the plurality of regions. In the generating of the audio data connection information, the audio data connection information about each of the plurality regions is generated in order to associate the acquired pieces of audio data with the corresponding plurality of regions.

Generating the audio data connection information includes generating information about an order in which the audio data are associated with the corresponding plurality of regions.

Acquiring the audio data may include receiving user input or selecting at least one audio data from an audio data list.

The audio data connection information may be metadata of the image data including dimensions and position of the specific region. Generating the audio data connection information may include adding information about a location where the acquired audio data is stored to the metadata.

Generating the audio data connection information may include displaying a visual feedback indicating an association of the audio data with the recognized specific region.

The method may further include further receiving a selection signal indicating selection of the recognized specific region and reproducing audio data associated with the specific region to which the selection signal is input using the audio data connection information.

Reproducing the audio data may include obtaining information about an order in which the audio data is associated with each of the plurality of regions and reproducing the audio data using the order information.

The image data may be still image data or moving image data.

In another embodiment, the method may include: displaying image data; obtaining a plurality of regions within the image data; acquiring pieces of audio data for respective ones of the plurality of regions; generating audio data connection information for each of the plurality of regions so as to logically link the acquired pieces of audio data to the corresponding regions; and storing the audio data connection information.

Obtaining the plurality of regions within the display area may include receiving user selection of a specific region in the display and obtaining the specific region selected by the user as one of the plurality of regions.

Alternatively, obtaining the plurality of regions within the display area may include obtaining a specific region containing predetermined features within the display area and obtaining the specific region as one of the plurality of regions.

According to another embodiment, there is provided an image processing apparatus for associating audio data with image data, including: a display unit displaying image data containing a specific region recognized in a photography standby mode; one or more processors; and a memory. The processor acquires audio data corresponding to the recognized specific region, generates audio data connection information needed for associating the acquired audio data with the recognized specific region, and stores the audio data connection information in the memory.

The specific region recognized in a photography standby mode of the image capturing apparatus may be a region defined for auto focus by the image capturing apparatus in the photography standby mode. The specific region may be a region identified by the image capturing apparatus as a face region in the photography standby mode.

When the recognized specific region consists of a plurality of regions, the processor may acquire the audio data corresponding to the plurality of regions and generate audio data connection information about each of the plurality regions in order to associate the acquired pieces of audio data with the corresponding plurality of regions.

The audio data connection information may be metadata of the image data including dimensions and position of the specific region. The processor may add information about a location where the acquired audio data is stored to the metadata.

The processor may receive a selection signal indicating selection of the recognized specific region and reproduce audio data associated with the specific region to which the selection signal is input using the audio data connection information.

In another embodiment, the image capturing apparatus may include: a display unit displaying image data; one or more processor; and a memory. The processor may identify a plurality of regions within the image data, acquire pieces of audio data for the respective plurality of regions, generate audio data connection information about each of the plurality of regions so as to logically link the acquired pieces of data to the corresponding regions, and store the audio data connection information about each of the plurality of regions.

### BRIEF DESCRIPTION OF THE DRAWINGS

The above and other features and advantages become apparent by describing in detail exemplary embodiments with reference to the attached drawings in which:

FIG. 1 is a block diagram of an image capturing apparatus, according to an embodiment;

FIG. 2 illustrates the construction of a processor in the image capturing apparatus of FIG. 1, according to an embodiment;

FIG. 3 illustrates audio data connection information, according to an embodiment;

FIG. 4 illustrates audio data connection information, according to another embodiment;

FIGS. 5A through 5C illustrate a method of acquiring at least one specific region in a display area, according to an embodiment;

FIG. 6 illustrates an icon indicating recording of audio data that will be associated with a specific region in image data, according to an embodiment;

FIG. 7 illustrates a process of recording audio data for a specific region in image data, according to an embodiment;

FIG. 8 illustrates an icon indicating the reproduction of audio data that will be associated with a specific region in image data, according to an embodiment;

FIG. 9 is a flowchart of a method of connecting audio data to image data, according to an embodiment; and

FIG. 10 is a flowchart of a method of connecting audio data to image data, according to another embodiment.

### DETAILED DESCRIPTION

An image capturing apparatus and a method of connecting audio data to corresponding image data, according to embodiments of, will now be described more fully with reference to the accompanying drawings, in which the exemplary embodiments of the invention are shown. The invention should not be construed as being limited to the embodiments set forth herein. Like numbers refer to like elements throughout this description and the drawings.

An image capturing apparatus, according to an embodiment, recognizes a specific region of a standby image being displayed in a photography standby mode so as to obtain image data. The image capturing apparatus then displays captured image corresponding to the image data including information indicating the recognized specific region.

A user selects a specific region from the displayed image data and simultaneously records audio data to be associated with the selected specific region. In this case, the image capturing apparatus creates audio data connection information associating the recorded audio data with the selected specific region.

In order to reproduce the audio data associated with a specific region, the user may select the specific region from displayed image data. The image capturing apparatus may search for audio data to be reproduced using position information about the audio data corresponding to the specific region contained in the audio data connection information. The found audio data may then be reproduced by the image capturing apparatus or an external device.

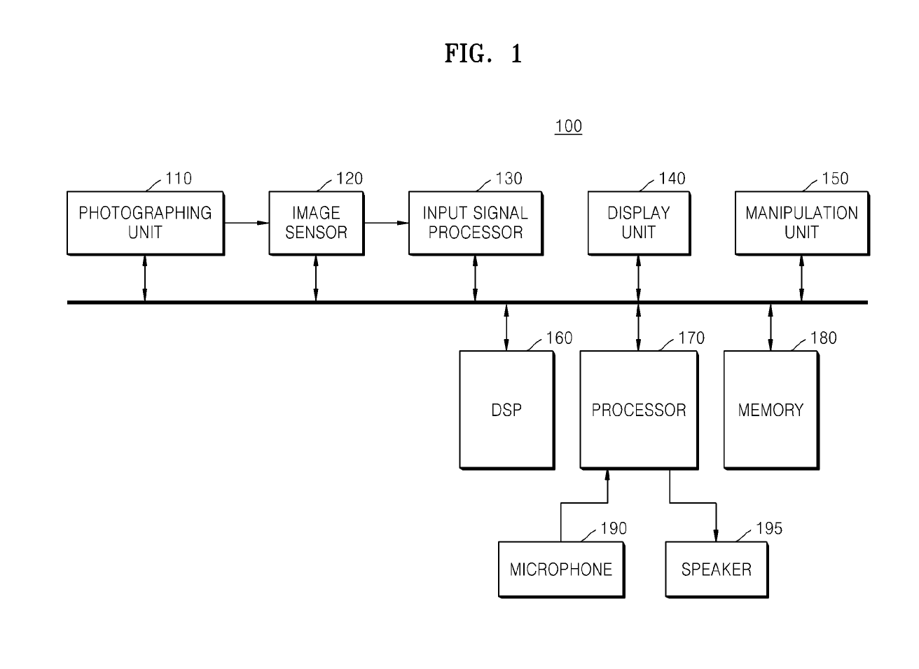

FIG. 1 is a block diagram of an image capturing apparatus 100, according to an embodiment.

Referring to FIG. 1, the image capturing apparatus 100 includes a photographing unit 110, an image sensor 120, an input signal processing unit 130, a display unit 140, a manipulation unit 150, a digital signal processor (DSP) 160, a processor 170, a memory 180, a microphone 190, and a speaker 195.

The image capturing apparatus 100 is configured to capture a still image or a moving image, processes captured image data or image data previously stored therein. The image capturing apparatus 100 may be any of various devices that can process data images, including digital cameras, camera phones, personal digital assistants (PDAs), portable multimedia players (PMPs), camcorders, smart phones, laptop computers, desktop computers, and digital TVs. In disclosed embodiments, the image capturing apparatus 100 implements a photographing function.

The photographing unit 110 includes a lens unit for focusing optical signals, an aperture for adjusting the intensity of the optical signals, and a shutter for controlling an input of the optical signals. For example, the lens unit may include a zoom lens for varying an angle of view depending on a focus length and a focus lens for focusing on an object being photographed. These lenses may be individual lenses or be constructed from a cluster having a plurality of lenses. In one embodiment, the shutter may be a mechanical shutter that moves up and down. Alternatively, the image sensor 120 may serve as the shutter by controlling the supply of an electrical signal.

The photographing unit 110 may further include a motor for driving the lens unit, the aperture, and the shutter. For example, the motor may drive the movement of the lens unit, open/shut of the aperture, and operate the shutter so as to perform auto focus (AF), automatic exposure (AE) control, aperture control, zooming, and manual focusing. In this case, the motor receives a control signal from the processor 170 to drive the lens unit, the aperture, and the shutter.

The image sensor 120 receives an optical signal from the photographing unit 110 and converts the optical signal into an electrical signal. For example, the image sensor 120 may be a Charge-Coupled Device (CCD) sensor or a Complementary Metal-Oxide Semiconductor (CMOS) sensor.

The input signal processing unit 130 converts an electrical signal received from the image sensor 120 into a digital form and produces a digital signal. The input signal processing unit 130 may also adjust a gain, regulate a waveform of the electrical signal output from the image sensor 120, and reduce noise therein.

The display unit 140 displays image data output from the input signal processing unit 130 in real time or image data previously stored in the memory 180. The display unit 140 may also display or present information provided by or for user in various forms such as icons, menus, and texts. Some examples of the display unit 140 are a Liquid Crystal Display (LCD), an Organic Light-Emitting Diode (OLED) display, an Active Matrix Organic Light Emitting Diode (AMOLED) display, and a touch screen that can recognize a touch input.

The manipulation unit 150 may include elements that enable a user to manipulate the image capturing apparatus 100 or perform settings for photography and/or videography. For example, the manipulation unit 150 may include a power button, a shutter button, a zoom button, and other function buttons. The manipulation unit 150 may be realized in any form that enables a user to input a control signal, including buttons, a keyboard, a touch pad, a touch screen, and a remote controller.

The memory 180 may store image data, audio data, data received from the input signal processing unit 130, data needed to perform operations, algorithms used for operation of a digital camera, and setting data. The memory 180 may temporarily store the result of operations. Data may be stored in the memory 180 using any number and/or type(s) of data structures. The memory 180 may be implemented by any number and/or type(s) of volatile memory such as a Static Random Access Memory (SRAM) and/or a Dynamic Random Access Memory (DRAM), and/or non-volatile memory such as a Read Only Memory (ROM), a flash memory, a hard disk, a Secure Digital (SD) memory card and/or a Multi-media Card (MMC).

The DSP 160 performs digital operations to process signals. For example, the DSP 160 may reduce noise in the input image data and perform image signal processing algorithms for image quality enhancement such as gamma correction, color filter interpolation, color matrix, color correction, or color enhancement. The DSP 160 may also compress the image data subjected to image signal processing into an image file and reconstructs the original image data from the image file. The image compression format used herein may be reversible or irreversible. For example, Joint Photographic Experts Group (JPEG) or JPEG 2000 may be used as the image compression format.

The example DSP 160 may, additionally and/or alternatively, perform sharpness processing, color processing, blur reduction, edge emphasis, image analysis processing, image recognition processing, or image effect processing. Image recognition may include face recognition and scene recognition. The face recognition or scene recognition may be performed using various known algorithms. The DSP 160 may also perform image signal processing so as to display image data on the display unit 140. For example, the DSP 160 may perform brightness level control, color correction, contrast control, edge emphasis control, screen division processing, or character image generation and synthesis. The DSP 160 may be connected to an external monitor (not shown), perform predetermined image signal processing, and transmit the image data obtained after the image signal processing to the external monitor so that the image data may be displayed on the external monitor.

The DSP 160 may generate AF data. More specifically, the DSP 160 may allow a brightness signal to pass through two different types of filters to produce two types of AF data having different frequency components. The example processor 170 of FIG. 1 uses the two types of AF data output from the DSP 160 to control the operation of the focus lens in the photographing unit 110.

The microphone 190 may receive a user's voice or ambient sounds. The speaker 195 outputs audio data that is associated with a specific region of the image data. For example, when the user selects a specific region of the image data, the processor 170 uses audio data connection information related to the image data to acquire audio data corresponding to the specific region and sends the acquired audio data to the speaker 195. The speaker 195 outputs the acquired audio data. In this case, the amplitude of a sound being output may be controlled by the user or the image capturing apparatus 100.

The processor 170 serves as an operation unit and a control unit by carrying out and/or executing machine-readable instructions, and sending signal-related commands to other elements of the image capturing apparatus 100. The processor 170 also sends manipulation commands to other elements in the image capturing apparatus 100 based on signals received from the manipulation unit 150 or the display unit 140. The processor 170 may include a single Central Processing Unit (CPU) or include a plurality of CPUs for executing respective commands. Alternatively, the machine-readable instructions may be carried out and/or executed by the CPU as well as the DSP 160.

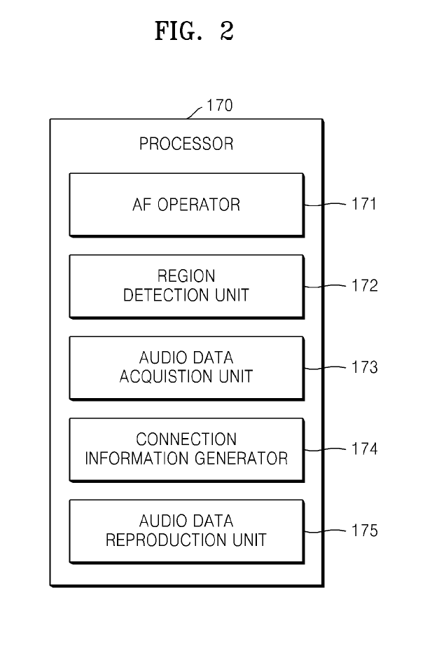

FIG. 2 illustrates the configuration of the processor 170 in the image capturing apparatus 100, according to an embodiment. Referring to FIG. 2, the processor 170 includes an AF operator 171, a region detection unit 172, an audio data acquisition unit 173, a connection information generator 174, and an audio data reproduction unit 175.

When an object being photographed is recognized by the user's manipulation or image recognition processing performed by the DSP 160, the AF operator 171 controls the operation of the focus lens so as to focus on the recognized object. For example, the AF operator 171 may calculate a focus position where the object is in the sharpest focus by using the AF data generated by the DSP 160. The AF operator 171 may also calculate a ratio between the two types of AF data having different frequency components obtained from the brightness signal and then control the motor of the photographing unit 110 so as to move the position of the focus lens based on the calculated ratio.

For AF operation, the image capturing apparatus 100 may have a focus adjustment window indicating an object being photographed and serving as a reference for auto focusing. The focus adjustment window may have a size and a location designated by a user or automatically determined by image recognition processing. If necessary, the image capturing apparatus 100 may have a plurality of focus adjustment windows. For example, if the DSP 160 performs image recognition processing to recognize a plurality of faces from one piece of image data, the same number and sizes of focus adjustment windows as the recognized faces may appear on a display area. A user may manipulate AF operation in a photography standby mode, for example, when the user presses a shutter button in the manipulation unit 150 halfway.

When the image data appears or is presented on the display unit 140, the region detection unit 172 obtains at least one specific region from the display area. In one embodiment, the region detection unit 172 may obtain a region defined for AF in the photography standby mode as the specific region. The defined region may be indicated on the display area by the focus adjustment window, and be located in the center of the display area or at a position automatically determined by image recognition processing. If a plurality of focus adjustment windows is detected, the user may select at least one specific region.

In another embodiment, the region detection unit 172 may obtain at least one specific region selected by the user from the display area. For example, if the display unit 140 is a touch screen configured to receive a user's touch input, the region detection unit 172 may receive a user's gesture to touch a portion of the display area on the touch screen and obtain a specific region corresponding to the touched portion. If the specific region is a quadrilateral, a user may select two diagonally opposing vertices of the quadrilateral to provide the position and dimensions of the specific region to the region detection unit 172. For example, a user may draw a closed curve on a portion of the display area and then determine the portion of the display area within the closed curve as the specific region. In another example, a user may also place a predetermined icon on a portion of the display area and determine the portion of the display area as the specific region. In another example, if a user's finger touches a predetermined portion of the display unit 140, a position corresponding to the center of the touched portion may be determined as the specific region.

In another embodiment, the region detection unit 172 identifies or determines a region recognized by image recognition processing as a specific region. For example, the DSP 160 may perform image recognition processing on image data stored in the memory 180 and provide information about a specific region containing a face or scene recognized by the image recognition processing to the region detection unit 172. In this case, the image recognition processing may be performed using various known recognition algorithms.

For example, acquisition of a facial region may include extracting specific features such as the eyes or lips from image data and acquiring the entire facial region based on a distance between the features. The region detection unit 172 may indicate a shape such as quadrilateral or circle around the specific region containing the recognized face and/or scene within the display area so that the user can identify or select the specific region.

Methods of obtaining at least one specific region from the display area according to the above-described embodiments may be performed separately, or in sequential or simultaneous combination. For example, if the region detection unit 172 determines a region defined for AF in a photography standby mode as the specific region, the image capturing apparatus 100 may receive user selection of a region other than the defined region. If the region detection unit 172 determines a region recognized by image recognition processing as the specific region, the image capturing apparatus 100 may receive user selection of a region other than the recognized region.

The audio data acquisition unit 173 acquires or obtains audio data that will be associated with and/or logically linked to the specific region obtained by the region detection unit 172. In one embodiment, the audio data acquisition unit 173 acquires audio data via the microphone 190. For example, upon user selection of a region identified by the region detection unit 172, the audio data acquisition unit 173 may receive audio data containing the user's voice explanation of the selected region via the microphone 190. For example, the audio data may be a user's voice or sound around the microphone 190. The audio data may contain detailed information regarding a person or object included in the specific region. In another embodiment, the audio data acquisition unit 173 acquires or obtains at least one audio data to be associated with the specific region from an audio data list provided by the display unit 140. The audio data list may be previously stored in the memory 180 before acquisition of image data, or be obtained from an external storage device via a wired/wireless network associated with the image capturing apparatus 100 before or after the acquisition thereof. The audio data list may also be provided using a second display unit that is associated with the image capturing apparatus 100 via a wired/wireless network. In this case, a user may select audio data that will be associated with the specific region through the second display unit, and the audio data acquisition unit 173 may determine the selected audio data as the audio data to be associated with the specific region.

In order to acquire audio data, the audio data acquisition unit 173 may fetch audio data or only position information about a location where the audio data is stored from the memory 180 or external storage device. The position information refers to a path to the location where audio data is stored. An absolute or relative path to audio data may be used as the position information.

Further, if the region detection unit 172 detects a plurality of regions, the audio data acquisition unit 173 may acquire all audio data corresponding to the plurality of regions or a portion of audio data corresponding to some of the plurality of regions.

The connection information generator 174 generates audio data connection information needed for connecting the audio data acquired by the audio data acquisition unit 173 to the specific region obtained by the region detection unit 172. If a plurality of regions is detected from a displayed image as a specific region, the connection information generator 174 may generate audio data connection information for each of the plurality of regions to which corresponding pieces of audio data are associated. The audio data connection information may be metadata related to image data. The metadata may contain information about a specific region and have a field containing audio data connection information that indicates the location of the audio data.

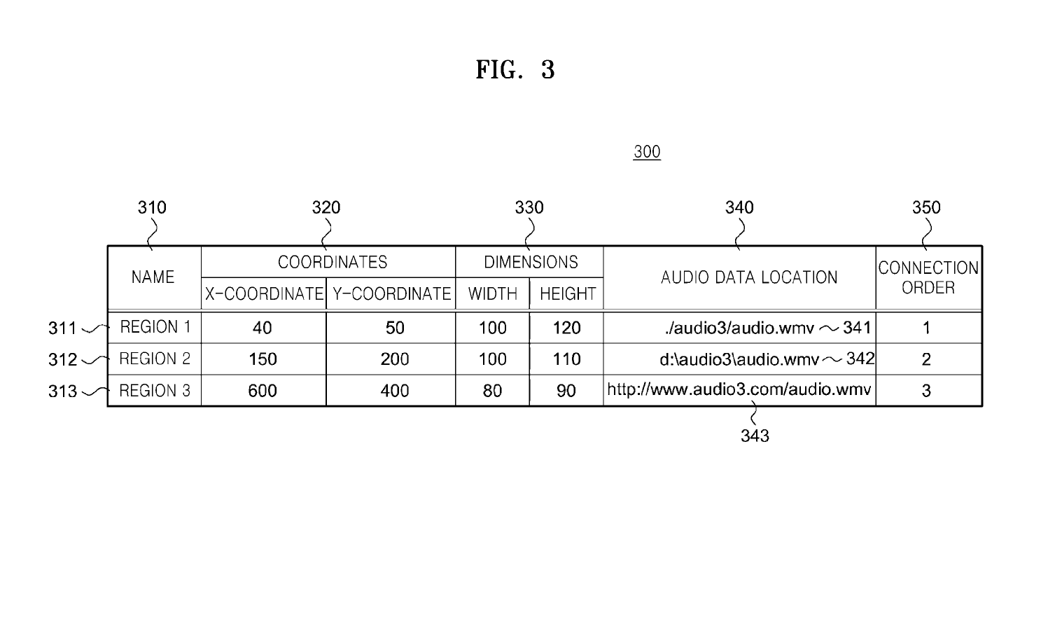

FIG. 3 illustrates audio data connection information 300, according to an embodiment.

Referring to FIG. 3, a specific region in the image data obtained as a result of image recognition processing includes first through third regions 311 through 313. When each of the first through third regions 311 through 313 is a quadrilateral, a region within the image data at which each of the first through third specific regions 311 through 313 is located is indicated using coordinates 320 and dimensions 330. For example, the position of the first region 311 may be indicated using coordinates (40, 50) when the origin of the coordinate system lies at the lowest left corner of the image data. The dimensions of the first region 311 are 100 pixels (width)×120 pixels (height). The first through third regions 311 through 313 have associated names 310.

Fields associated with the first through third regions 311 through 313 respectively contain information about audio data location 340. The audio data location 340 is indicated by an absolute or relative path. The audio data location 341 corresponding to the first region 311 is a relative path that represents the location of audio.wav data contained in an audio3 folder that is a subfolder to a folder set one level higher than the current folder where the image data is stored.

The audio data location 342 corresponding to the second region 312 represents an absolute path where the audio data is located. The audio data location 342 is placed on an audio3 folder on the d: drive. The d: drive may be a logical drive on the memory 180 and/or on an external memory connected to the image capturing apparatus 100 using a wired/wireless connection. The audio data location 343 corresponding to the third region 313 contains an Internet address 343. In this case, when a specific region is selected from the display area, the image capturing apparatus 100 may acquire audio data via the Internet and reproduce the acquired audio data in real-time. The image capturing apparatus 100 may fetch all audio data connected to image data prior to user selection of the specific region and store the audio data in the memory 180.

When pieces of audio data corresponding to a respective plurality of regions are obtained, the connection information generator 174 generates order information 350 about the order in which the corresponding pieces of audio data were associated. For example, if the pieces of audio data are associated in the order from the first region 311 to the third region 313, the connection information generator 174 adds the order information 350 to the fields associated with the first through third regions 311 through 313. For example, because the first region 311 was the first to be associated, it has an order information 350 value of 1. Further, upon reproduction of a plurality of pieces of audio data associated with the image data, the image capturing apparatus 100 sequentially reproduces the pieces of audio data corresponding to the respective plurality of regions 311 through 313 using the order information 350 included in the audio data connection information 300.

The image capturing apparatus 100 may store audio data connection information 300 in the memory 180 or an external storage device together with or separately from the image data.

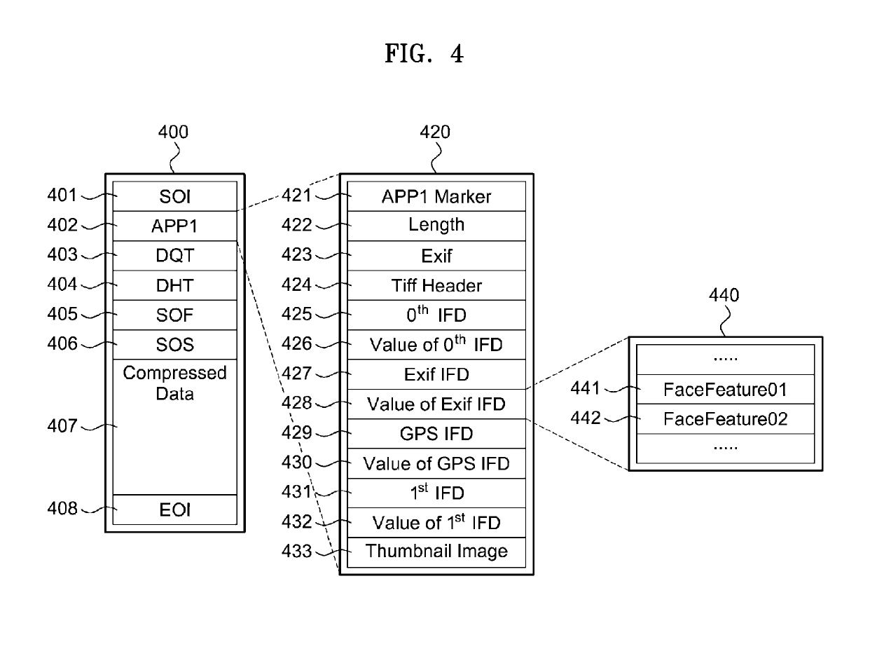

FIG. 4 illustrates audio data connection information stored within the JPEG compression format, according to an embodiment. More specifically, the audio data connection information is stored in the Exchangeable Image File Format (Exif) data of the existing JPEG format. Exif is a specification for the image file format used by digital cameras and may be used to store photo metadata such as camera manufacturer, camera model, orientation, date and time when a picture is taken, focus length, and shutter speed.

Referring to FIG. 4, a JPEG format 400 is divided by codes by a plurality of markers, namely a 501 marker 401, an APP1 marker 402, a DQT marker 403, a DHT marker 404, an SOF marker 405, an SOS marker 406, a compressed image data 407, and an EOI marker 408, each of which is binary data starting with the word 0xFF. Data containing information on each of the markers 401 through 408 can begin with the corresponding marker. The JPEG format 400 includes the SOI marker 401, the APP1 marker 402, the DQT marker 403, the DHT marker 404, the SOF marker 405, the SOS marker 406, the compressed image data 407, and the EOI marker 408. The SOI marker 401 and the EOI marker 408 do not include any data. More specifically, the SOI marker 401 marks the start of image data and the APP1 marker 402 is related to user application. The DQT marker 403 is followed by a quantization table, and the DHT marker 404 defines a Huffman table. The SOF marker 405 and the SOS marker 406 are used to identify a frame header and a scan header, respectively. The EOI marker 408 marks the end of the image data.

In this case, data with the APP1 marker 402 can be arranged in an APP1 format 420 identified by a plurality of marker codes. The APP1 format 420 contains data related to Exif and various attribute information. As shown in FIG. 4, the APP1 format 420 consists of an APP1 marker 421, a Length marker 422, an Exif marker 423, a Tiff Header marker 424, a 0^{th} IFD marker 425, a Value of 0^{th} IFD marker 426, an Exif IFD marker 427, a Value of Exif IFD marker 428, a GSP IFD marker 429, a Value of GSP IFD marker 430, a 1^{st} IFD marker 431, a Value of 1^{st} IFD marker 432, and thumbnail data 433.

More specifically, the APP1 marker 421 designates the location of a user application and the Length marker 422 indicates the size of the user application. The Exif marker 423 indicates an Exif identifier code, and the Tiff Header marker 424 contains an offset value that indicates an IFD address. The 0^{th} IFD marker 425 indicates attribute information about primary image data such as image size, the Exif IFD pointer, and the pointer to the GPS IFD. The Value of the 0^{th} IFD marker 426 indicates data values for information contained in the 0^{th} IFD. The Exif IFD marker 427 contains attribute information specific to the Exif format, and the Value of Exif IFD 428 indicates data values for information contained in the Exif IFD. The GPS IFD marker 429 is used to record GPS information regarding the image data. The Value of GPS IFD marker 430 indicates data values for information contained in the GPS IFD. The 1^{st} IFD marker 431 indicates attribute information about thumbnail data in the image data, and the Value of the 1^{st} IFD marker 432 records data values for information contained in the 1^{st} IFD.

A data region 440 associated with the Value of the Exif IFD marker 428 may include markers 441 and 442 related to specific regions obtained by the region detection unit 172. The data region 440 containing the markers 441 and 442 associated with the specific regions may include position information and dimension information regarding each of the specific regions and information about audio data that will be associated with the corresponding specific regions, as described above in connection with FIG. 3. The position information may contain x and y coordinates that each specific region is placed within the image data. The dimension information may contain width and height of the specific region. The audio data information may include location information about audio data or the audio data itself. If the audio data information contains the audio data, the size of the data region 440 or audio data may be restricted (e.g., less than 64 KB) since the size of the APP1 segment may be limited according to a JPEG standard. Further, if the audio data are associated with the corresponding specific regions in a predetermined order, the data region 440 corresponding to the respective specific regions may also contain the order information.

Upon user selection of the specific region, the audio data reproduction unit 175 searches for audio data that is associated with the specific region using the audio data connection information and reproduces the identified audio data via the speaker 195.

In order to receive a signal indicating selection of a specific region in the display area, the image capturing apparatus 100 may provide a predetermined icon on the specific region or one side of the display unit 140. The image capturing apparatus 100 may also display a progress bar on one side of the display unit 140 to visualize the reproduction progress of audio data in real-time as the audio data is reproduced.

If the audio data connection information concerning each of the specific regions contains reproduction order information, the audio data reproduction unit 175 may reproduce the audio data in the order specified in the reproduction order information. In order to notify a user of the specific region corresponding to audio data being currently reproduced, the audio data reproduction unit 175 may also highlight the specific region or change the status of an icon representing the specific region.

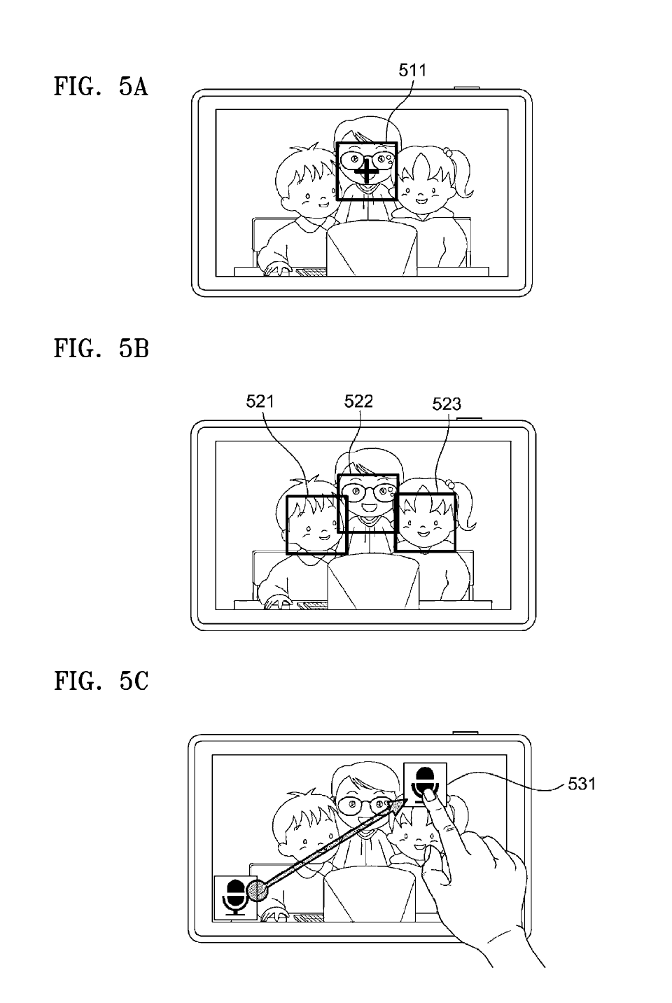

FIGS. 5A, 5B, 5C and 6 through 8 illustrate example processes of acquiring at least one specific region in a display area, associating audio data to the specific region, and reproducing the associated audio data, according to an embodiment.

FIGS. 5A through 5C illustrate a process of acquiring at least one specific region in a display area provided on the display unit 140, according to an embodiment.

FIG. 5A shows an example region 511 defined for AF in a photography standby mode. The defined region 511 may be indicated by a focus adjustment window. The size and position of the focus adjustment window may be preset by a user or image capturing apparatus 100. For example, as shown in FIG. 5A, the focus adjustment window may have a quadrilateral shape that is located at the center of a display area. The image capturing apparatus 100 acquires the defined region 511 as the specific region and associates audio data with the specific region.

FIG. 5B shows examples regions 521 through 523 detected by image recognition processing. For example, the specific region may be a region defined for AF in a photography standby mode or a region detected by performing image recognition processing on the stored image data. Information about the positions and dimensions of the specific regions 521 through 523 may be contained in metadata related to displayed image data as described above with reference to FIGS. 3 and 4, or be stored separately from the image data.

FIG. 5C shows a specific region designated or selected by a user. To achieve this, the user may place a microphone-shaped icon 531 on a portion of a display area. Referring to FIG. 5C, if the user drags the icon 531 to the portion of the display area and stops touching it, information about the position on the display area finally touched may be used as position information about the specific region. Alternatively, the user may designate a specific region by directly drawing a closed curve or open curve similar to the closed curve on a portion of the display area. For example, if the specific region is a quadrilateral, the user may designate the specific region by touching positions corresponding to vertices or surface of the quadrilateral.

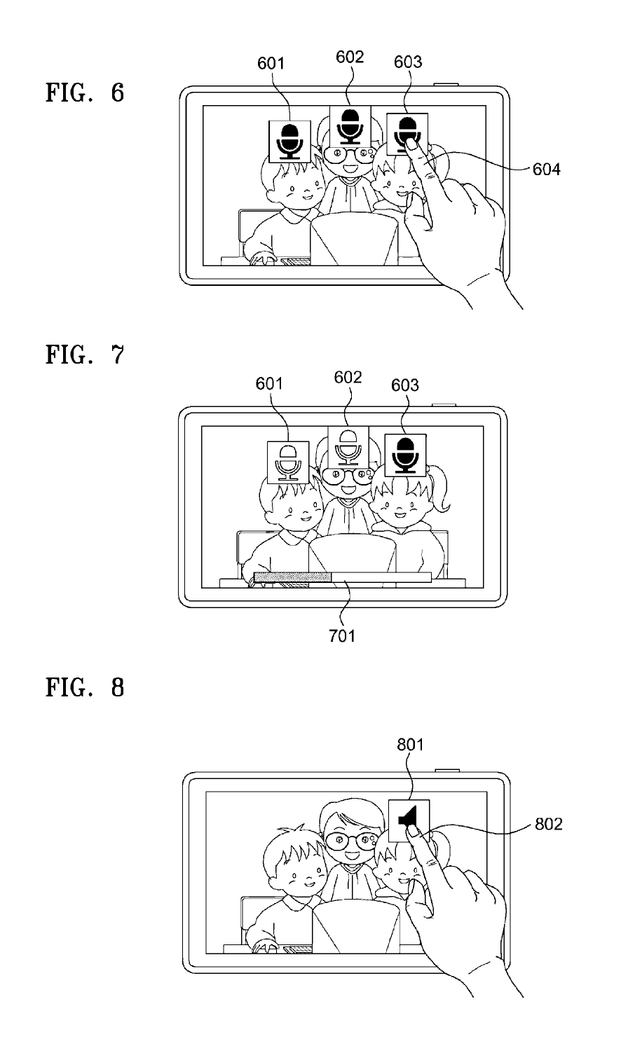

FIG. 6 illustrates icons 601 through 603 representing recording of audio data that will be associated with regions in image data, according to an embodiment

Referring to FIG. 6, the icons 601 through 603 automatically appear immediately after detection of a plurality of regions by the region detection unit 172. Alternatively, as described above with reference to FIG. 5C, if a user directly drags an icon to the specific region and stops touching the icon, the icon may appear on the specific region.

When a plurality of regions is detected and icons identifying the respective plurality of specific regions appear on the display unit 140, the user selects one icon 603 (604) to start recording of audio data that will be associated with the corresponding specific region.

FIG. 7 illustrates a process of recording audio data for a selected specific region in image data, according to an embodiment. Referring to FIG. 7, a user selects an icon identifying the specific region to record audio data that will be associated with the specific region.

For example, the plurality of icons 601 through 603 may basically provide visual feedback indicating that they are in an activated state. When the user selects the icon 603, the plurality of icons 601 through 603 may provide visual feedback indicating that the remaining icons 601 and 602 are in an inactivate state.

Alternatively, the plurality of icons 601 through 603 provide visual feedback indicating that they are in an inactivate state. When the user selects the icon 603, the plurality of icons 601 through 603 may provide visual feedback indicating that only the selected icon 603 is in an activate state

In this way, the user is able to distinguish an icon identifying a specific region selected for recording from the remaining icons. Further, if the recording time of audio data that will be associated with the specific region is preset, the display unit 140 displays a progress bar 701 to show how much of the available recording time has been consumed.

FIG. 8 illustrates an icon 801 representing the reproduction of audio data that will be associated with a specific region in image data, according to an embodiment. Referring to FIG. 8, when recording of the audio data that will be associated with a specific region in the image data is finished as illustrated in FIG. 7, the icon 801 representing that the audio data may be reproduced appears on the specific region. Alternatively, if stored image data contains a specific region to which audio data is associated, the icon 801 representing that the audio data may be reproduced may appear on the image data being displayed. The icon 801 is shaped like a speaker, which indicates that the audio data is ready for reproduction. Upon user selection (802) of the icon 801, the image capturing apparatus 100 is able to reproduce audio data associated with the specific region through the speaker 195.

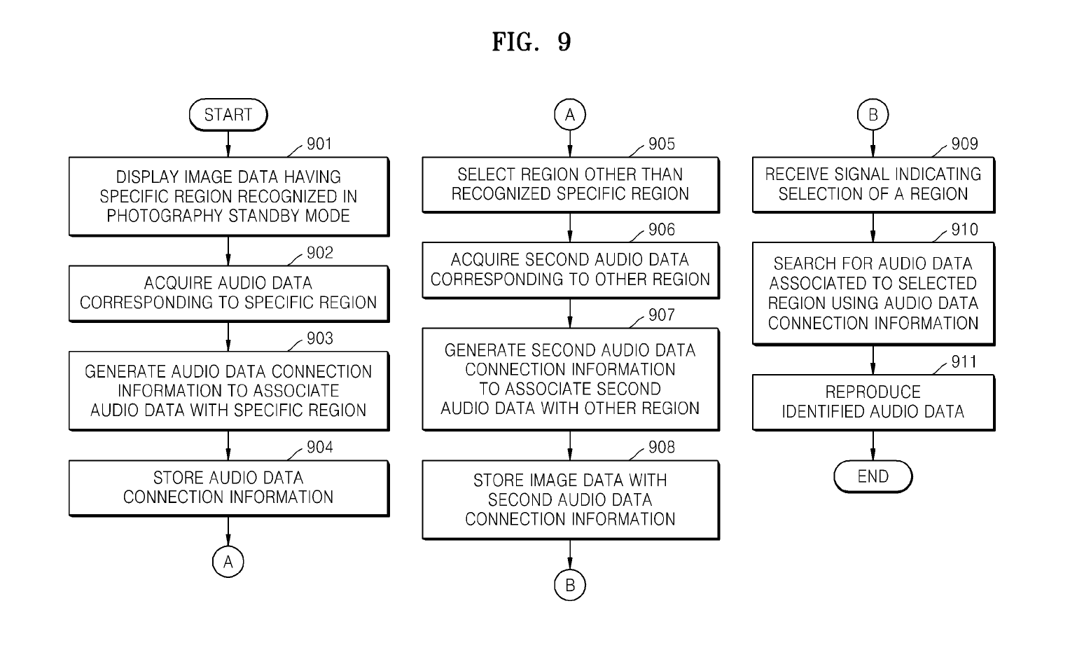

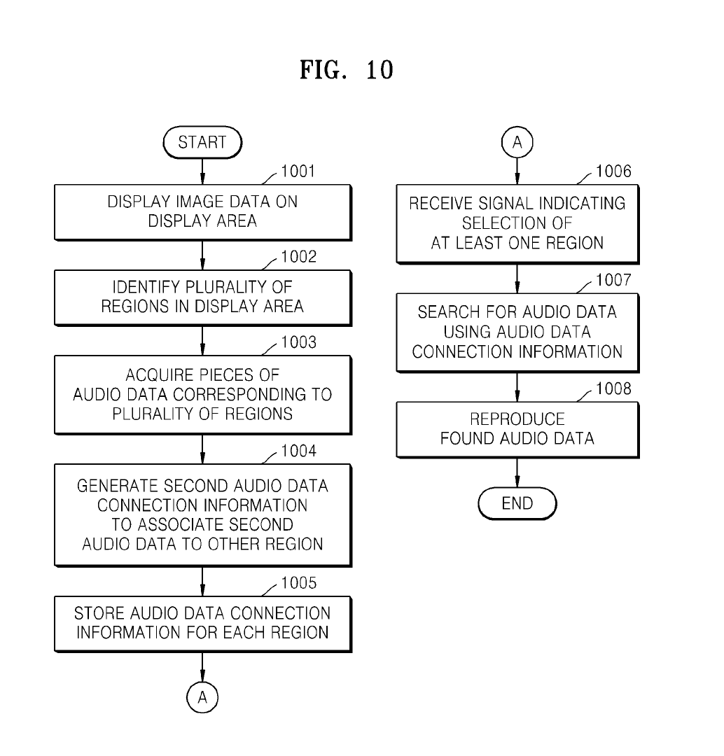

FIG. 9 is a flowchart of a method of associated audio data with image data, according to an embodiment.

Referring to FIG. 9, in operation 901, the image capturing apparatus 100 (see FIG. 1) displays image data having a specific region recognized in a photography standby mode indicated therein. The recognized specific region may be a region defined for AF in a photography standby mode. Alternatively, the specific region may be a face or scene detected by performing image recognition processing. In operation 902, the image capturing apparatus 100 acquires audio data corresponding to the recognized specific region. To achieve this, the image capturing apparatus 100 may receive audio data from a user or select the audio data from an audio data list. In operation 903, the image capturing apparatus 100 generates audio data connection information needed to connect the audio data to the specific region. For example, the audio data connection information may be metadata related to the image data. The metadata may contain dimensions and location of the specific region. A field associated with the specific region may contain information indicating the location of the audio data. In operation 904, the image capturing apparatus 100 then stores the audio data connection information associated with the audio data in the memory 180 or external storage device, together with image data or in a separate file.

In operation 905, the image capturing apparatus 100 receives a region other than the recognized specific region that may be selected by a user or detected by the image recognition processing. In operation 906, the image capturing apparatus 100 then acquires second audio data corresponding to the other region. In operation 907, the image capturing apparatus 100 generates second audio data connection information needed for associating the second audio data with the other region in operation 907 and in operation 908, stores the second audio data connection information in the memory 180 or a memory in an external device, together with image data and/or in a separate file.

Upon detection of the specific region or other region, the image capturing apparatus 100 provides a highlight function or icon indicating the detected regions through the display unit 140. When audio data is associated with at least one of the regions, the image capturing apparatus 100 also provides visual feedback indicating the connection status through the display unit 140.

In operation 909, the image capturing apparatus 100 receives a signal indicating selection of at least one of the specific region and the other region from the user. In operation 910, the image capturing apparatus 100 uses the audio data connection information to search for audio data associated with the region selected by the user. In operation 911, the image capturing apparatus 100 reproduces the identified audio data via the speaker 195 or an external speaker.

FIG. 10 is a flowchart of a method of associated audio data with image data, according to another embodiment.

Referring to FIG. 10, in operation 1001, the image capturing apparatus 100 displays image data on a display area thereof. In operation 1002, the image capturing apparatus 100 identifies a plurality of regions from the display area. For example, the plurality of regions may be defined for AF in a photography standby mode, detected by image recognition processing, or designated by a user. In operation 1003, the image capturing apparatus 100 acquires audio data for each of the plurality of regions. For example, the image capturing apparatus 100 may receive audio data through the microphone 190, or acquire the audio data from an audio data list. In operation 1004, the image capturing apparatus 100 generates audio data connection information about each region in order to associate the pieces of audio data with the corresponding regions. For example, the audio data connection information may be metadata related to the image data. In operation 1005, the image capturing apparatus 100 then stores the audio data connection information about each region in the memory 180 or a memory in an external device.

In operation 1006, the image capturing apparatus 100 receives a signal indicating selection of at least one of the plurality of regions from a user. In operation 1007, the image capturing apparatus 100 uses the audio data connection information to search for audio data being associated with the at least one region selected by the user. In operation 1008, the image capturing apparatus 100 reproduces the found audio data via the speaker 195 or a speaker of an external device, together with image data and/or in a separate file.

The methods of associating audio data with image data, according to embodiments, can be implemented through machine-readable instructions that can be recorded or stored on a tangible article of manufacture such as a computer-readable storage media and executed by one or more processors. The machine-readable instructions may include individual or a combination of program instructions, data files, and data structures. The program instructions being recorded on the computer-readable storage media can be specially designed or constructed are known to and used by a person skilled in the art of computer software. Examples of the computer readable storage media include magnetic media (e.g., hard disks, floppy disks, magnetic tapes, etc), optical recording media (e.g., CD-ROMs, or DVDs), magneto-optical media such as floppy disks, and/or hardware devices specially configured to store and perform program instructions (ROM, RAM, flash memories, etc). Computer-readable storage media may be distributed over network coupled computer systems so that the machine-readable instructions are stored and/or executed in a distributed fashion. This media can be read by the computer, stored in the memory, and executed by the processor. Examples of program instructions include machine language codes produced by a compiler and high-level language codes that can be executed by a computer using an interpreter. The hardware devices can be constructed as one or more software modules in order to perform the operations according to embodiments of the invention, and vice versa.

Also, using the disclosure herein, programmers of ordinary skill in the art to which the invention pertains can easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein can be performed in any suitable order unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all equivalent means and differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

While the invention has been particularly shown and described with reference to exemplary embodiments thereof, it will be understood by those of ordinary skill in the art that various changes in form and details may be made therein without departing from the spirit and scope of the invention as defined by the following claims or their equivalents.

What is claimed is:

1. A method comprising:
displaying image data having indicated thereon a specific region that is recognized in a photography standby mode of an image capturing apparatus;
acquiring audio data corresponding to the recognized specific region;
generating audio data connection information to associate the acquired audio data with the recognized specific region; and
storing the generated audio data connection information.

2. The method of claim 1, wherein the specific region recognized in a photography standby mode of the image capturing apparatus comprises a region defined for auto focus by the image capturing apparatus in the photography standby mode.

3. The method of claim 1, wherein the specific region recognized in the photography standby mode of the image capturing apparatus comprises a region identified by the image capturing apparatus as a face region in the photography standby mode.

4. The method of claim 1, wherein the recognized specific region includes a plurality of regions,
wherein in the acquiring of the audio data, the audio data is acquired for each of the plurality of regions, and
wherein in the generating of the audio data connection information, the audio data connection information about each of the plurality regions is generated in order to associate the acquired pieces of audio data with the corresponding plurality of regions.

5. The method of claim 4, wherein the generating of the audio data connection information includes generating information about an order in which the audio data are connected to the corresponding plurality of regions.

6. The method of claim 1, wherein the acquiring of the audio data includes receiving user input or selecting at least one audio data from an audio data list.

7. The method of claim 1, wherein the audio data connection information comprises metadata of the image data including dimensions and position of the specific region, and
wherein the generating of the audio data connection information includes adding information about a location where the acquired audio data is stored to the metadata.

8. The method of claim 1, wherein the generating of the audio data connection information includes displaying a visual feedback indicating an association of the audio data with the recognized specific region.

9. The method of claim 1, further comprising displaying a selection signal indicating an association of the recognized specific region and reproducing audio data associated with the specific region to which the selection signal is input using the audio data connection information.

10. The method of claim 9, wherein the reproducing of the audio data comprises obtaining information about an order in which the audio data is associated with each of the plurality of regions and reproducing the audio data using the order information.

11. A method comprising:
displaying image data;
identifying a plurality of regions within the image data;
acquiring a plurality of pieces of audio data for respective ones of the plurality of regions;
generating audio data connection information for each of the plurality of regions so as to logically link the pieces of acquired audio data to the corresponding regions; and
storing the audio data connection information together with the image data.

12. The method of claim 11, wherein the plurality of regions are defined for auto focus by the image capturing apparatus in a photography standby mode.

13. The method of claim 11, wherein the plurality of regions are identified by the image capturing apparatus as face regions in the photography standby mode.

14. An apparatus comprising:
a display unit to display image data containing a specific region recognized in a photography standby mode;
a memory to store the image data; and
a processor to acquire audio data corresponding to the recognized specific region, generate audio data connection information needed for associating the acquired audio data with the recognized specific region, and store the audio data connection information in the memory.

15. The apparatus of claim 14, wherein the specific region recognized in the photography standby mode of the image capturing apparatus comprises a region defined for auto focus by the image capturing apparatus in the photography standby mode.

16. The apparatus of claim 14, wherein the specific region recognized in the photography standby mode of the image capturing apparatus comprises a region identified by the image capturing apparatus as a face region in the photography standby mode.

17. The apparatus of claim 14, wherein when the recognized specific region consists of a plurality of regions, the processor is to acquire the audio data corresponding to the plurality of regions and generate audio data connection information about each of the plurality regions to associate the acquired pieces of audio data with the corresponding plurality of regions.

18. The apparatus of claim 14, wherein the audio data connection information comprises metadata of the image data containing dimensions and position of the specific region, and
wherein the processor is to add information about a location where the acquired audio data is stored to the metadata.

19. The apparatus of claim 14, wherein the processor is to receive a selection signal indicating selection of the recognized specific region and reproduces audio data associated with the specific region to which the selection signal is input using the audio data connection information.

20. An image capturing apparatus comprising:
a display unit to display image data;
a memory to store the image data; and
a processor to identify a plurality of regions within the image data, to obtain a plurality of pieces of audio data for respective ones of the plurality of regions, to generate audio data connection information associating the plurality of pieces of audio data with respective ones of the plurality of regions, and to store the audio data connection information about each of the plurality of regions.

21. A tangible article of manufacture comprising a computer-readable storage medium storing machine-readable instructions that, when executed, cause a machine to at least:
display image data;
identify a plurality of regions within the image data;
obtain a plurality of pieces of audio data for respective ones of the plurality of regions;
generate audio data connection information to logically link respective ones of the pieces of audio data to the regions; and
store the audio data connection information together.
